(19) United States
(12) Patent Application Publication
(10) Pub. No.: US 2005/0130604 A1
(43) Pub. Date: Jun. 16, 2005

(54) Electronic device having a physical configuration that is dependent upon its operational status

(75) Inventors: Jan Chipchase, Tokyo (JP); Fujii Takaharu, Kanagawa (JP)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/722,966

(22) Filed: Nov. 26, 2003

(51) Int. Cl. H04B 1/38; H04M 1/00

(52) U.S. Cl. 455/90.3; 455/575.1; 455/567

(57) ABSTRACT

An electronic device, having an exterior surface, the electronic device comprising: an actuator for providing, when enabled, a first texture at a first portion of the exterior surface of the electronic device and for providing, when disabled, a second texture at the first portion of exterior surface of the electronic device; a user interface for changing the status of the electronic device from a first status to a second status; and a processor operable to enable the actuator during the first status and disable the actuator during the second status.

### FIELD OF THE INVENTION

Embodiments of the invention relate to an electronic device that has a physical configuration that is dependent upon its operational status.

### BACKGROUND TO THE INVENTION

Portable electronic devices currently use a variety of different mechanisms to provide information to a user. The mechanism used may depend upon circumstances. If immediate user action is required an audio alert or a vibration alert are suitable. The display of visual information is suitable when immediate user action is not required, for example, to indicate status information such as the operation mode of the device or whether there is unread mail in an Inbox.

The above-described current mechanisms are not practical in all circumstances or not socially acceptable. For example, audio feedback can disturb a user's neighbours, a vibration alert is unsuitable for extended periods of activation because it consumes large amounts of power and the display of visual information is not always visible in very bright or dark conditions. Furthermore in some societies it may be considered rude to look at an electronic device, while in conversation with another person as it may suggest boredom.

### BRIEF SUMMARY OF THE INVENTION

According to one embodiment of the invention there is provided an electronic device, having an exterior surface, the electronic device comprising:
an actuator for providing, when enabled, a first texture at a first portion of the exterior surface of the electronic device and for providing, when disabled, a second texture at the first portion of exterior surface of the electronic device; a user interface for changing the status of the electronic device from a first status to a second status; and a processor operable to enable the actuator during the first status and disable the actuator during the second status.

According to another embodiment of the invention there is provided a user-replaceable cover for an electronic device, the cover comprising: an exterior surface; means for providing, when enabled, a first texture at a first portion of the exterior surface; and an interface for forming an electrical connection with the electronic device.

According to another embodiment of the invention there is provided a method of controlling an electronic device comprising: providing a first configuration of a surface area of the electronic device; receiving user input to change the operational status of the device; and providing a second configuration of the surface area of the electronic device instead of the first configuration.

Embodiments of the invention therefore provide an electronic device that has a physical configuration that is dependent upon its operational status.

Embodiments of the invention therefore allow feedback to be given to the user in a silent manner without the user having to look at the phone.

Texture includes changing the surface shape, in particular changing surface shape by creating and removing projections on the surface of the device

### BRIEF DESCRIPTION OF THE DRAWINGS

For a better understanding of the present invention reference will now be made by way of example only to the accompanying drawings in which:

FIG. 1 schematically illustrates a portable electronic device comprising at least one actuator;

FIG. 2 illustrates one embodiment of an actuator mechanism that uses a polymer sheet;

FIG. 3 illustrates an alternative embodiment of an actuator mechanism that uses plural polymer sheets;

FIG. 4 illustrates an alternative embodiment of an actuator mechanism that uses cam wheels and a stepper motor;

FIGS. 5A and 5B. illustrate an implementation in which the electronic device is a headset accessory for a mobile cellular telephone; and

FIGS. 6A and 6B illustrate an implementation in which the electronic device is a mobile cellular telephone.

### DETAILED DESCRIPTION OF EMBODIMENTS OF THE INVENTION

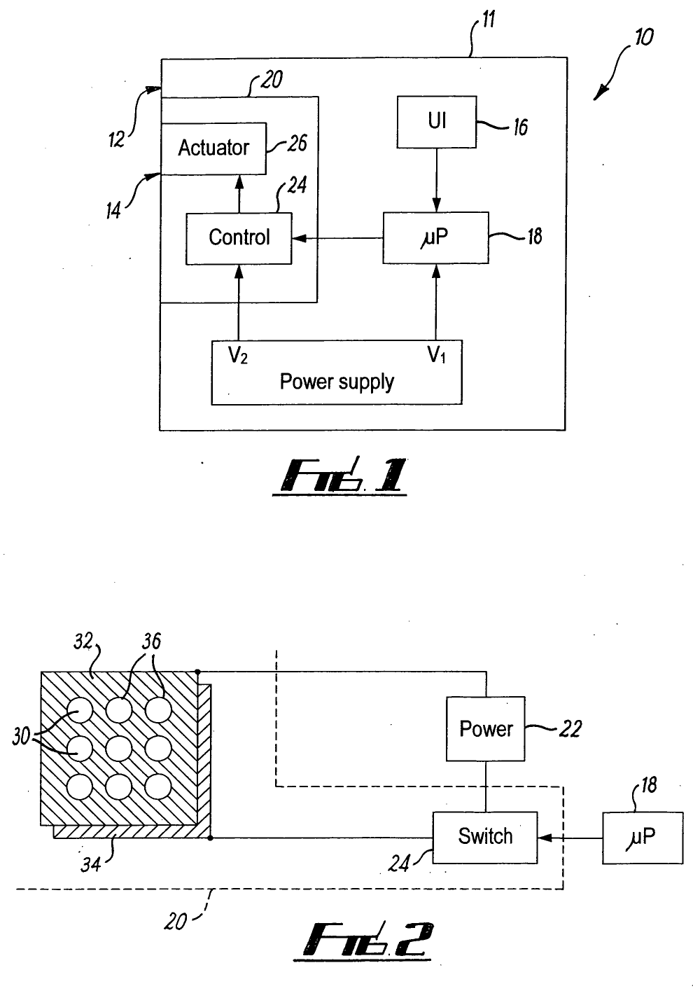

FIG. 1 schematically illustrates a portable electronic device 10 that has a body 11 with an exterior surface 12. The portable electronic device 10 comprises at least one actuator mechanism 20, a user interface 16 and a processor 18. The processor 18 is connected to receive commands from the user interface 16 and is connected to control the actuator mechanism 20.

Only as many components are described as are necessary to explain the implementation of the invention. Other embodiments of the invention may comprise additional components or alternative, functionally equivalent components.

The actuator mechanism 20 comprises a control device 24 and an actuator 26. The control device 24 may be a switch that is controlled by the processor 18 to connect a power supply 22 to the actuator 26.

The processor 18 is operable to control the status of the electronic device 10.

When the device has a first status, the processor 18 operates to close the switch 24 and enable the actuator 26. When the device has a second status, the processor 18 operates to open the switch 24 and disable the actuator 26.

The first and second status may be operational modes of the electronic device. In some embodiments, immediate user attention is not necessary when the electronic device has the first status.

The exterior surface 12 has a first portion 14, the texture of which is controlled by the actuator 26. Typically the actuator 26 comprises extendible projections, which are extended when the actuator is enabled and retracted when the actuator is disabled.

When the actuator 26 is enabled the first portion 14 has a texture that is rough or bumpy to the touch. When the actuator 26 is disabled the first portion 14 has a texture that feels relatively smooth to the touch.

Thus a rough or bumpy texture is continuously provided at the first portion 14 of the exterior surface 12 while the electronic device has the first status and a smooth texture is continuously provided at the first portion 14 of the exterior surface 12 while the electronic device has the second status.

In this example, the user interface 16 allows a user to control the processor 18 to change the status of the electronic device 10 from a first status to a second status. The user interface 16 may be the only means of changing from the first status to the second status. The user interface 16 may also allow a user to control the processor 18 to change the status of the electronic device 10 from the second status to the first status. The user interface 16 may be the only means of changing from the second status to the first status.

One embodiment of the actuator mechanism is illustrated in FIG. 2. The actuator 26 comprises a sheet of polymer material 30 positioned between a first outer electrode 32 and a second inner electrode 34. The sheet of polymer material 30 is ‘sandwiched’ between the first outer electrode 32 and second inner electrode 34.

The outer electrode 32 is discontinuous, in this example having a regular 3×3 array of circular apertures 36.

The application of a high voltage across the first outer electrode 32 and the second inner electrode, when the switch 24 is closed by the processor 18, enables the actuator 26 and results in a deformation of the polymer sheet 30. The outer electrode is itself rigid or reinforced by a rigid support, so that the deformed polymer extends through the apertures 36 to form bump projections. The collection of bump projections forms a rough surface. When the switch 24 is opened by the processor 18, the actuator is disabled and the resilient polymer sheet is no longer deformed and no longer projects significantly through the apertures 36.

The power and direction of the deformation of the polymer sheet depend upon the polymer material used in the polymer sheet. If a transparent polymer sheet is required gel of acryl or polyurethane may be used. The power consumption of an enabled actuator of size 1 cm²×0.02 cm is less than 1 mW and the applied voltage may be of the order of 500V.

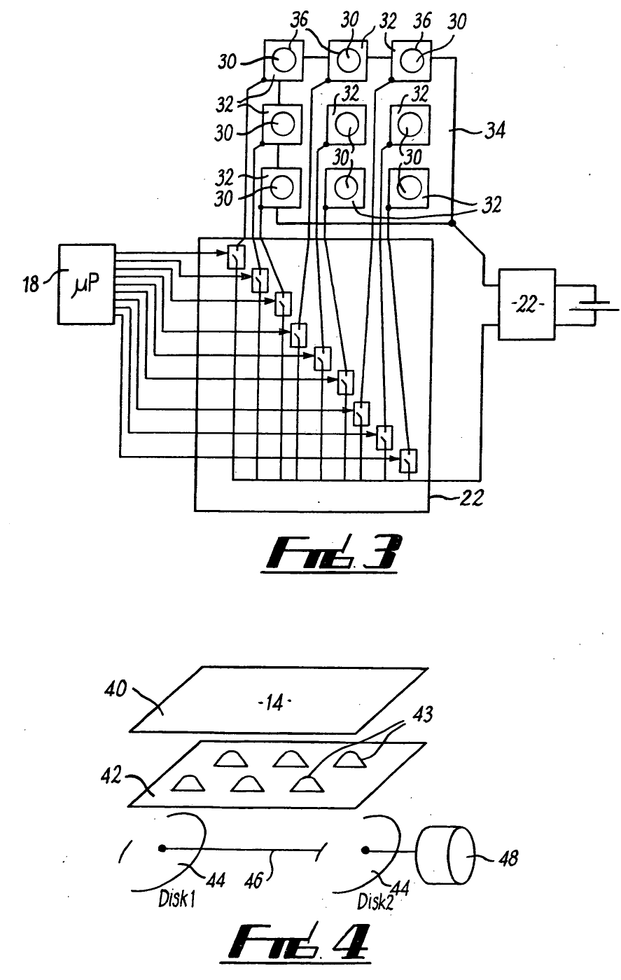

An alternative embodiment of the actuator mechanism 12 is illustrated in FIG. 3. The actuator mechanism 12 comprises a plurality of actuators 26 and a control device 24. Each actuator 26 comprises a sheet of polymer material 30 positioned between its own associated first outer electrode 32 and a common shared second inner electrode 34. Thus each sheet of polymer material 30 is ‘sandwiched’ between a different first outer electrode 32 and the common second inner electrode 34. Each outer electrode 32 is discontinuous, in this example having a single circular aperture 36.

Although, in this example, each actuator has its own polymer sheet, in other embodiments, the actuators may use a common polymer sheet.

The control device 24 comprises a plurality of switches, each of which is used to selectively connect one of the outer electrodes 32 to the power supply 22. Each of the switches is independently controlled by the processor 18.

The processor 18 is operable to selectively close any one or more of the plurality of switches in the control device 24 and thereby selectively enable any one or more of the actuators 26. The application of a high voltage across the first outer electrode 32 and the second inner electrode, when the switch is closed, enables the actuator 26 and results in a deformation of the polymer sheet 30. The outer electrode is itself rigid or reinforced by a rigid support, so that the deformed polymer extends through the aperture 36 to form a bump projection.

The constituent components of an actuator 26 include a sheet of polymer material, A discontinuous rigid outer electrode 32 and a rigid inner second electrode 34. The rigidity of the electrodes ensures that the polymer extends through the outer electrodes discontinuities when the actuator 26 is enabled.

The discontinuous rigid outer electrode may be formed using the rigid body 11 of the electronic device 10. The interior surface of the body corresponding to the first portion 14 of the exterior surface 12 of the body 11 is coated with electrically conductive material to for the discontinuous outer electrode. The combination of the rigid body and the conductive material provides a rigid electrode and aperture(s) in the body provide the discontinuities.

The rigid inner electrode may be formed from a rigid substrate and an overlying electrically conductive material.

The polymer sheet 30 may additionally have electrically conductive material on its upper and lower surfaces to help the formation of a galvanic connection with the respective outer electrode 32 and inner electrode 34.

Another alternative embodiment of the actuator mechanism 12 is illustrated in FIG. 4. The actuator mechanism comprises a upper sheet 40 at the first portion 14 of the exterior surface 12, a lower sheer 42, cam wheels 44, a shaft 46 and a stepper motor 48.

The lower sheet 42 has an upper surface with a plurality of rigid upwardly extending projections 43 on it. The lower sheet 42 is separated from the upper sheet 40. The lower sheet 42 is, however, upwardly movable so that it contacts the upper sheet 40. When the lower sheet 42 is forced upwards its projections 43 deform the upper sheet 40 and form projections on the first portion 14 of the exterior surface 12.

The cam wheels 44 are mounted on the shaft 46 which is rotated between a first position and a second position. In the first position the cam wheels force the lower sheet 42 upwards such that projections are formed on the first portion 14 of the exterior surface 12. In the second position, the cam wheels 44 do not force the lower sheet 42 upwards against the upper sheet 40. As the cam wheels 44 rotate away from the first position, a resilient bias between the lower sheet 42 and the upper sheet 40 separates the sheets and the projections are removed from the first portion 14 of the exterior surface 12.

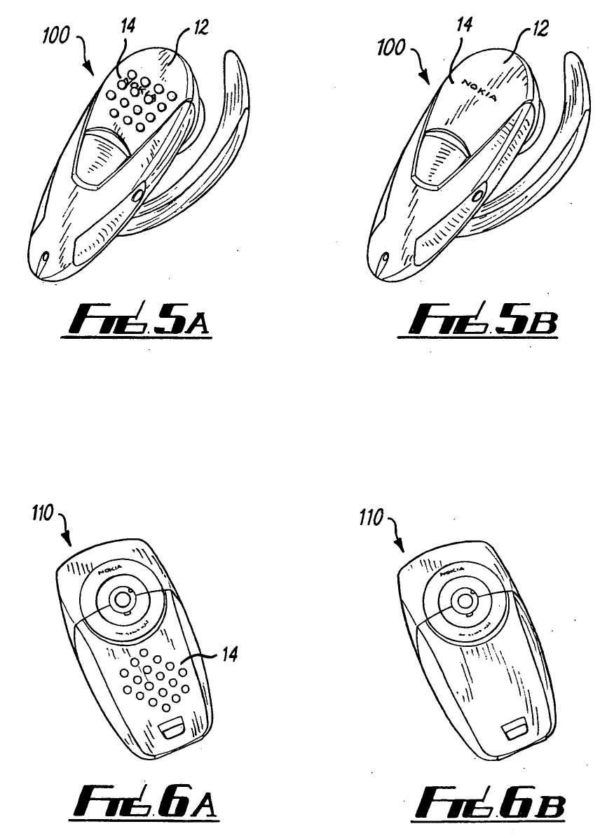

In one implementation. the electronic device 10 is an accessory for a mobile cellular telephone, such as a headset 100 as illustrated in FIGS. 5A and 5B. The headset 100 is operational when it has the first status and is non-operational when it has the second status. The headset 100 presents a rough textured surface on its exterior surface 12 at the first portion 14 when the headset is switched on (FIG. 5A) and presents a smooth surface when it is switched off (FIG. 5B). A user is able to determine whether the headset is operational by touching the headset 100 while it is being worn. The size of the first portion 14 is such that it allows easy location without looking, but not too big to reduce power consumption. The location of the first portion 14 may be indicated by a permanent tactile indicator on the surface of the body 11.

In another implementation, the electronic device 10 is a mobile cellular telephone 110 as illustrated in FIGS. 6A and 6B. The mobile cellular telephone 110 presents a rough textured surface on a first portion 14 of its back cover surface when the mobile telephone is in a mute mode and presents a smooth surface when the telephone is not in a mute mode. A mute mode is a mode in which incoming communications such as a telephone call or text message are not audibly alerted. When the mobile telephone is not in a mute mode incoming communications such as a telephone call or text message are audibly alerted. A user is able to determine whether the mobile cellular telephone is muted by touching the back cover of the telephone. Thus a phone in a handbag can be felt to confirm it is in a ‘silent’ mode which may be useful when the user is in a dark cinema. The size of the first portion 14 is such that it allows easy location without looking, but not too big to reduce power consumption. The location of the first portion may be indicated by a permanent tactile indicator on the surface of the back cover.

In another implementation, the electronic device 10 is a mobile cellular telephone. The mobile cellular telephone presents a rough textured surface on both of its lateral sides when the mobile telephone is being used for gaming. That is when a user is playing an electronic game using the mobile telephone. The rough textured surface provides grip for the user while game playing. The size and configuration of the first portion is such that it allows good grip, but not too big to avoid excessive power consumption.

The actuators 26 described in the preceding paragraphs may be integrated into user-replaceable covers for the electronic device 10. The cover provides the first portion 14 of the exterior surface 14 of the body 11 of the electronic device 10. The cover will have an interface for forming an electrical connection with the control device 22 housed in the electronic device 10.

The operation of the electronic device may be user configurable. The electronic device may have a plurality of actuators 26 on different surfaces of the device and the user may program the device so that the information conveyed by a rough texture on a particular surface is chosen by the user. Although the first portion 14 in the above described embodiments is directly accessible to a user, it possible to have the first portion indirectly accessible. That is accessible behind a user movable screen.

Although embodiments of the present invention have been described in the preceding paragraphs with reference to various examples, it should be appreciated that modifications to the examples given can be made without departing from the spirit and scope of the invention as claimed. For example although the textured surface has been described as rough or bumpy, it should be appreciated that in other embodiments of the invention other changes to the surface configuration of the device are made that can be discriminated by human touch.

1. An electronic device, having an exterior surface, the electronic device comprising:
an actuator for providing, when enabled, a first texture at a first portion of the exterior surface of the electronic device and for providing, when disabled, a second texture at the first portion of exterior surface of the electronic device;
a user interface for changing the status of the electronic device from a first status to a second status; and
a processor operable to enable the actuator during the first status and disable the actuator during the second status.

2. An electronic device as claimed in claim 1, wherein the first texture provides discontinuities in the first portion of the exterior surface.

3. An electronic device as claimed in claim 1, wherein the first texture feels bumpy or rough to the touch.

4. An electronic device as claimed in claim 3, wherein the second texture feels relatively smooth to the touch.

5. An electronic device as claimed in claim 1, wherein the actuator continuously provides the first texture at the first portion of the exterior surface of the electronic device while the electronic device has the first status.

6. An electronic device as claimed in claim 5, wherein the actuator continuously provides the second texture at the first portion of the exterior surface of the electronic device while the electronic device has the second status.

7. An electronic device as claimed in claim 1, wherein the actuator comprises extendible projections, which are extended when the actuator is enabled and retracted when the actuator is disabled.

8. An electronic device as claimed in claim 1, wherein the actuator comprises extendible projections, which are extended when the actuator is disabled and retracted when the actuator is enabled.

9. An electronic device as claimed in claim 1, wherein the actuator comprises one or more polymer actuators.

10. An electronic device as claimed in claim 1, wherein the actuator comprises one or more stepper motors.

11. An electronic device as claimed in claim 1, wherein the electronic device comprises a plurality of actuators and the processor is operable to selectively enable the actuators.

12. An electronic device as claimed in claim 1, wherein the first status of the electronic device is changeable to the second status only via user interface.

13. An electronic device as claimed in claim 1, wherein the actuator when enabled is indicative of an operational mode of the electronic device.

14. An electronic device as claimed in claim 1, wherein immediate user attention is not necessary when the electronic device has the first status.

15. An electronic device as claimed in claim 1, wherein the electronic device is operational when it has the first status and is non-operational when it has the second status.

16. An electronic device as claimed in claim 1, wherein the electronic device is mute when it has the first status and is not mute when it has the second status.

17. An electronic device as claimed in claim 1, wherein the electronic device is being used as a gaming device when it has the first status.

18. An electronic device as claimed in claim 1, wherein the exterior surface of the electronic device is directly or indirectly accessible to the user

19. An electronic device as claimed in claim 1, operable as a mobile cellular telephone

20. An electronic device as claimed in claim 1 operable as an accessory for a mobile cellular telephone.

21. A user-replaceable cover for an electronic device as claimed in acclaim 1, providing at least the first portion of the exterior surface of the electronic device and comprising the actuator.

22. A user-replaceable cover for an electronic device, the cover comprising:
An exterior surface;
means for providing, when enabled, a first texture at a first portion of the exterior surface; and
an interface for forming an electrical connection with the electronic device.

23. A method of controlling an electronic device comprising:
providing a first configuration of a surface area of the electronic device;
receiving user input to change the operational status of the device; and
providing a second configuration of the surface area of the electronic device instead of the first configuration.
